(19) United States
(12) Patent Application Publication
(10) Pub. No.: US 2006/0074600 A1
(43) Pub. Date: Apr. 6, 2006

(54) Method for providing integrity measurements with their respective time stamps

(76) Inventors: Manoj R. Sastry, Portland, OR (US); Willard M. Wiseman, Vernonia, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/943,093

(22) Filed: Sep. 15, 2004

(51) Int. Cl. G06F 15/00

(52) U.S. Cl. 702/187

(57) ABSTRACT

According to one embodiment of the invention, a method comprises conducting a first integrity measurement to produce a first integrity measurement event. Thereafter, an integrity time stamp associated with the first integrity measurement event is created. The integrity time stamp is used to identify the actual time when the first integrity measurement event was produced.

### 1. FIELD

Embodiments of the invention generally relate to the field of information security. More specifically, embodiments of the invention relate to a method conducted within a trusted computing platform for associating integrity measurement events with actual time.

### 2. GENERAL BACKGROUND

Over the last decade, the growing popularity of networks, namely a widespread connection of computing platforms, has greatly enhanced workforce productivity and influenced the daily activities for many individuals. Personal computers and other types of computing platforms are now considered invaluable business and communication tools. Therefore, with the growing number of viruses, trojan horses and other malicious code propagating over the networks, it is becoming increasingly important to protect the integrity of information within a computing platform.

Many types of computing platforms, such as personal computers for example, are typically configured with an open, standard architecture. As a result, personal computer users have not been able to fully trust the operations of their computers. Herein, the term “trust” is an expectation that a component within a computing platform or the computing platform itself will behave in a particular manner for a specific purpose.

The Trusted Computing Group (TCG), an industry standards body driven to enhance the security of the computing environments across multiple platforms, has collectively developed a fully integrated security device referred to as a “Trusted Platform Module” or “TPM”. The TPM is configured to provide secure storage and report integrity metrics, namely measured results during integrity measurement operations on various components (called measured components) within a computing platform. The integrity metrics are made available to a challenger when evaluating the trustworthiness of the computing platform. A “challenger” is an entity that requests and has the ability to intepret the integrity metrics of a computing platform.

Upon validation of these results, the challenger is only aware of the sequential relationship between integrity metrics. The conventional operations of the TPM, however, fail to provide the actual moment of time “when” these integrity metrics were measured. This poses a number of disadvantages.

For instance, the lack of information, in units of actual time, does not provide the challenger with information about when the integrity measurement was performed. Providing information about when the integrity measurement was performed, however, gives the challenger more data for making a trust decision. As an illustrative example, during attestation, some challengers may consider a measured component with a stale integrity metric, namely a metric of a measured component where an unacceptable time period has elapsed since it was measured, has an elevated chance of being compromised. Thus, the actual time information is quite important for these challengers. Another disadvantage is that the lack of actual time information associated with the measured components used in the digital signature may prevent the use of the digital signature as evidence to establish generation before a particular time or within a particular session.

### BRIEF DESCRIPTION OF THE DRAWINGS

Embodiments of the invention may best be understood by referring to the following description and accompanying drawings.

FIG. 1 is an exemplary embodiment of a computing platform.

FIG. 2 is an exemplary embodiment of the TPM implemented within the computing platform of FIG. 1.

FIG. 3 is an exemplary embodiment of stored content pertaining to each tick counter within the TPM of FIG. 2.

FIG. 4 is an exemplary embodiment of a procedure for storing and reporting integrity metrics.

FIG. 5 is an exemplary embodiment of a method of associating ticks produced by a tick counter with units of actual time.

FIG. 6 is an exemplary embodiment of a method for establishing a timestamp session over a predetermined duration of time.

FIG. 7 is an exemplary embodiment of a method for creating a time stamp for a TPM operation.

FIG. 8 is an exemplary embodiment of a timestamping operation to provide a verified time of when an operating system (OS) boots.

### DETAILED DESCRIPTION

In general, various embodiments of the invention describe a method for associating integrity measurement events with actual time. More specifically, one embodiment of the invention pertains to the creation of an integrity time stamp based on an integrity measurement conducted on a component to indicate when the component was measured.

According to one embodiment of the invention, the integrity time stamp is produced based on the operations of a tick counter during a Trusted Platform Module (TPM) Transport Session (TTS). The tick counter is used to establish a chronological relationship between the beginning and end of an Integrity Metric Session (IMS) and the events (caused by the issuance of commands) within it. An “IMS” is a series of Integrity Measurement Events (IMEs) that are chronologically associated. Each IME is an integrity metric, namely a measured result obtained during an integrity measurement operation. According to one embodiment of the invention, the IME may be represented as a hash value and subsequently stored in an extended (accumulated) manner into specific volatile memory of the computing platform.

The above-described association with actual time is initially established by logic, namely hardware, software, firmware or any combination thereof, performing an event within the TPM Transport Session, which triggers commencement of an IMS. Successive events within the IMS are separated in time by a number tick counts conducted by the tick counter. For instance, the tick count difference between the first event and a current second event is readily available by substracting the tick count value assigned to the second event from the tick count value assigned to the first event. By associating the tick count values generated by the tick counter during the IMS to actual time (e.g., real measured time or some relative but constant time kept by a challenger attesting the computing platform), the actual time when integrity measurement events are performed during the TPM Transport Session (TTS) may be ascertained. As a result, an “integrity time stamp,” namely the actual time information indicating when a component was measured, may be attached to the IME for that component.

This integrity time stamp provides challengers with additional information to make more informed decisions as to whether to trust the attested computing platforms. To illustrate this point, the use of integrity time stamps would enable challengers to adopt a policy that accepts a report of integrity metrics and trusts an attested computing platform if the integrity metrics of the measured components were measured within a prescribed period of time from receipt of the report (e.g., one week, few hours, etc.).

Moreover, by associating the tick counters within each IMS to actual time, a chronological relationship between different IMSes may also be established. This allows the challenger to discern whether a particular IMS occurs before or even overlaps another IMS.

The following detailed description references accompanying drawings presented largely in terms of block diagrams and flowcharts to collectively illustrate embodiments of the invention. Well-known circuits or process operations are not discussed in detail to avoid unnecessarily obscuring the understanding of this description. Of course, other embodiments may be utilized and derived therefrom, such that physical and logical substitutions may be possible. The following detailed description, therefore, should not be taken in a limiting sense, and the scope of various embodiments of the invention is defined only by the appended claims, along with the full range of equivalents to which such claims are entitled.

Certain terminology is used to describe certain features within various embodiments of the invention. For example, a “computing platform” may be any electronic device with information processing capability. Examples of computing platforms include, but are not limited or restricted to the following: a computer (e.g., desktop, laptop, portable, tablet, server, mainframe, etc.), a communications transceiver (e.g., alphanumeric pager, handheld, cellular telephone, etc.) network equipment (e.g., router, brouter, modem, etc.), a set-top box, a personal digital assistant (PDA), a digital audio player, a game console or handheld, or the like.

The term “interconnect” is generally defined as any medium or a collection of mediums that is capable of transferring information from one location to another. Examples of an interconnect may include, but are not limited or restricted to one or more electrical wires, cable, optical fiber, bus traces, or air when communications maintained by a wireless transmitter and receiver.

The term “logic” represents any hardware, software or firmware implemented within the computing platform while “component” represents any hardware, software or firmware implemented within the computing platform or any information stored within the security device. The term “actual time” may be represented by any unit of measure including, but not limited or restricted to a date (e.g., calendar day, month, year or any combination), hour, minute, second, fraction of a second, or any combination or grouping thereof.

“Software” includes a series of instructions that, when executed, performs a certain function. Examples of software, but are not limited or restricted to an operating system, an application, an applet, a program or even a routine. The software may be stored in a machine-readable medium, which includes but is not limited to an electronic circuit, a semiconductor memory device, a read only memory (ROM), a flash memory, a type of erasable programmable ROM (EPROM or EEPROM), a floppy diskette, a compact disk, an optical disk, a hard disk, or the like.

I. General Architecture

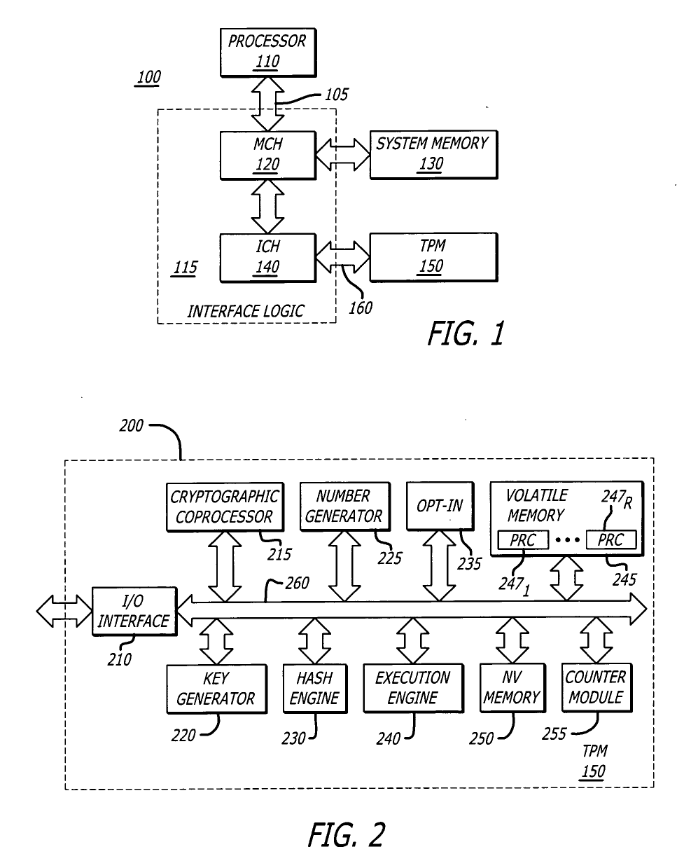

Referring to FIG. 1, an exemplary embodiment of a TPM-based computing platform 100 is shown. Computing platform 100 comprises a processor 110 and interface logic 115 coupled to a system memory 130 and a Trusted Platform Module (TPM) 150. The interface logic 115 controls the communications between hardware components 110, 130 and 150. According to one embodiment of the invention, interface logic 115 is a chipset. According to another embodiment of the invention, interface logic 115 comprises a memory control hub (MCH) 120 and an input/output (I/O) control hub (ICH) 140. The hardware components of platform 100 may be employed on any substrate (e.g., circuit board, removable card, etc.) or on multiple substrates.

As shown in FIG. 1, processor 110 represents a processing unit of any type of processor architecture. Examples of different types of processing units include, but are not limted or restricted to a general purpose microprocessor, a digital signal processor, a coprocessor, an application specific integrated circuit (ASIC), a microcontroller, a state machine, and the like. Examples of different types of processor architecture include complex instruction set computers (CISC), reduced instruction set computers (RISC), very long instruction word (VLIW), or a hybrid architecture. Of course, as an alternative embodiment, processor 110 comprises multiple processing units coupled together over a common host bus (not shown).

Coupled to processor 110 via an interconnect 105 as shown in FIG. 1, MCH 120 may be integrated into a chipset that provides control and configuration of memory and I/O devices such as system memory 130 and ICH 140. Typically, adapted to store system code and data, system memory 130 is typically implemented with a type of dynamic random access memory (DRAM) or static random access memory (SRAM).

ICH 140 may also be integrated into a chipset together with or separate from MCH 120 to perform I/O functionality. As shown, ICH 140 supports communications with TPM 150 via an interconnect 160. Also, ICH 140 supports communications with components coupled to other interconects such as a Peripheral Component Interconnect (PCI) bus at any selected frequency (e.g., 66 megahertz “MHz”, 133 MHz, etc.), an Industry Standard Architecture (ISA) bus, a Universal Serial Bus (USB), a firmware hub bus, or any other type of interconnect.

Referring to FIG. 2, an exemplary embodiment of TPM 150 is shown. TPM 150 is adapted to report the integrity of computing platform 100 as well as components implemented therein, allowing computing platform 100 to boot to an operating system (OS) even with untrusted components installed. This allows an external resource (e.g., a computing platform operating as a challenger) to determine the trustworthiness of computing platform 100 without preventing access to computing platform 100 by the user.

According to one embodiment of the invention, TPM 150 comprises one or more integrated circuits placed within a protective package 200. For instance, a protective package 200 may be any type of IC package such as an IC package for a single IC or a multi-chip package. Alternatively, protective package 200 may include a cartridge or casing covering a removable circuit board featuring the integrated circuit(s) and the like.

As further shown in FIG. 2, TPM 150 comprises any combination of the following components: I/O interface 210, a cryptographic coprocessor 215, a key generator 220, a number generator 225, a hash engine 230, an opt-in 235, an execution engine 240, a volatile memory 245, a non-volatile memory 250 and a counter module 255. These components 210-255 are in communication over an interconnect 260. Further discussion of these components is set forth in a TCG specification entitled “TPM Main Part 1 Design Principles Specification Version 1.2, Revision 62” published on or around 2 Oct. 2003 (hereinafter referred to as “TPM Version 1.2 Specification”).

According to this embodiment of the invention, I/O interface 210 manages the flow of information over interconnect 260 as well as enforces access policies associated with opt-in component 235 and other TPM functions requiring access control. I/O interface 210 further performs protocol encoding/decoding suitable for communication over internally externally and internally positioned within TPM 150.

Cryptographic coprocessor 215 is adapted to perform cryptographic operations within TPM 150. For instance, cryptographic coprocessor 215 is configured to perform asymmetric key encryption/decryption in accordance with a Rivest, Shamir and Adleman (RSA) based function. Of course, other asymmetric functions may be used in lieu of RSA-based functions, such as Digital Signature Algorithm (DSA), Elliptic Curve, Data Encryption Algorithm (DEA) as specified in Data Encryption Standard (DES), and the like. Moreover, symmetric key encryption/decryption may be performed by cryptographic coprocessor 215 for internal use within TPM 150.

Cryptographic coprocessor 215 is further adapted to operate in cooperation with number generator 225, which may be a pseudo random number generator or a random number generator. One illustrative embodiment of a random number generator comprises a state machine that accepts and mixes unpredictable data and a post-processor that has a one-way hash function. Cryptographic coprocessor 215 uses values from number generator 225 to generate random data (e.g., nonce) or asymmetric keys as well as to provide randomness in digital signatures.

As further shown in FIG. 2, key generator 220 is adapted to create asymmetric key pairs and symmetric keys. The private key of the key pair is held in a shielded (protected) location within volatile memory 245 or non-volatile memory 250.

Hash engine 230 conducts one-way hash functions on input information. A portion of the input information may be provided from a source external to TPM 150, such as the results of integrity measurements conducted by computing platform 100 of FIG. 1. One type of hash function is Secure Hash Algorithm (SHA-1) as specified a 1995 publication Secure Hash Standard FIPS 180-1 entitled “Federal Information Processing Standards Publication” (Apr. 17, 1995).

Opt-in component 235 provides mechanisms and protections to allow TPM 150 to be activate/deactivated as well as to enable or disable certain functionality of TPM 150.

Execution engine 240 runs program code to execute TPM commands received from I/O interface 210. This ensures that operations are properly segregated and shield locations within volatile memory are protected. A “shielded location” is an area where data is protected against interference and prying, independent of its form.

Volatile memory 245 includes storage of an aggregation of integrity metrics produced by integrity measurements conducted within TPM 150. Such storage is accomplished by a plurality of memory units referred to as “Platform Configuration Registers” (PCRs) 247₁-247_{R} (R≧2, R=16 for this embodiment). More specifically, each PCR is a N-bit storage location (e.g., N≧160) that stores a cumulatively updated hash value constituting an updated, aggregated integrity metric.

Non-volatile memory 250 is used to store persistent identity and state information associated with TPM 150. For instance, an endorsement key, namely a key pair (e.g., 2048-bit RSA key pair) generated and stored prior to receipt by the end user, such as during manufacturer or distribution for example, may be stored therein. The endorsement key comprises a public portion (PUBEK) and a private portion (PRIVEK).

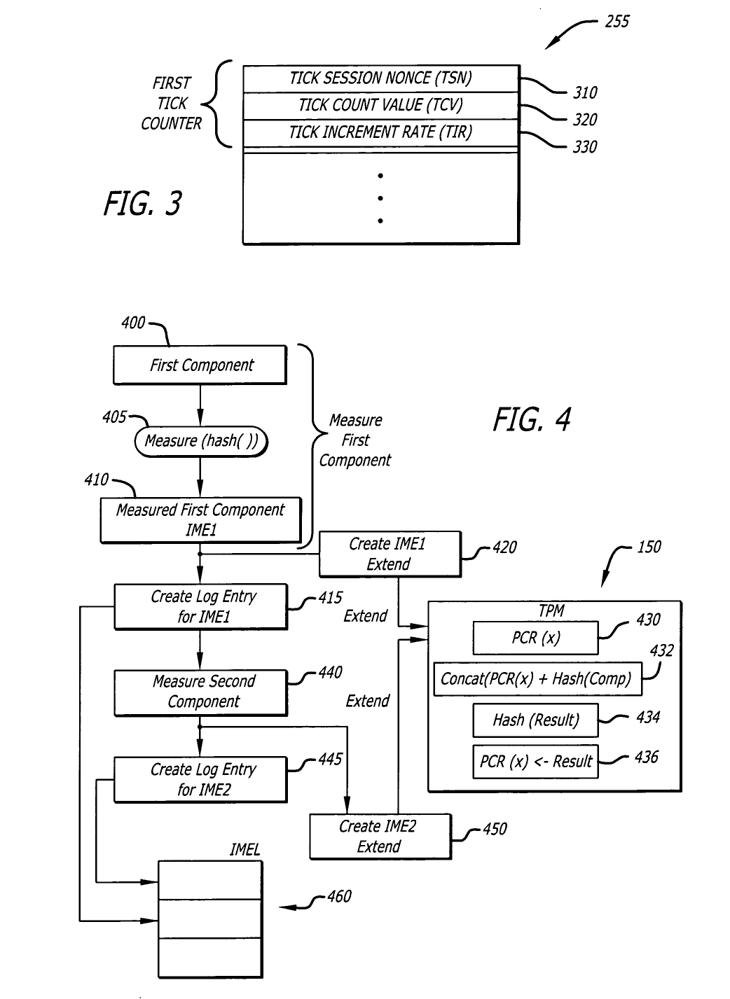

Counter module 255 comprises one or more “tick counters,” which enables TPM 150 to count from the start of a particular communication session referred to as a “tick session”. As shown in FIG. 3, for each tick counter, TPM maintains a tick session nonce 310, a tick count value 320, and a tick increment rate 330.

Herein, tick session nonce (TSN) 310 is set at the start of each tick session and tick count value (TCV) 320 is set to 0. TCV 320 maintains the number of ticks for a tick (or timing) session by incrementing its counter, normally once per constant time period. The rate at which TCV 320 is increased is set by tick increment rate (TIR) 330. Normally set during manufacturing of TPM 150 of FIG. 2 and/or platform 100 of FIG. 1, TIR 330 sets a predetermined relationship between ticks and a unit of actual time (e.g., months, weeks, days, hours, minites, seconds, multiples or fractions of seconds, etc.).

It is contemplated that TCV 320 may be used to maintain the tick count by initially setting TCV 320 to a predetermined value and decrementing its counter. It is further contemplated that TPM 150 of FIG. 2 may include additional components other than those discussed, and may in fact include a subset of these components.

II. Integrity Measurements

The TCG architecture provides a method for secure storage and reporting of integrity metrics. An exemplary embodiment of a procedure for storing and reporting integrity metrics is shown in FIG. 4. This embodiment is provided for illustrative purposes only. It is contemplated that a number of other procedures may be used to conduct integrity measurements.

A TPM-based computing platform enables integrity measurements to be conducted for components with the platform. As illustrated in FIG. 4, for example, a first component 400 is measured to produce IME data (IMEL) 410 associated with measured first component. As shown, IME1 410 is produced by first component 400 undergoing a hash operation 405 to produce a hashed value. An Integrity Management Event Log (IMEL) entry 415 for IME1 is created and the resulting IME1 is extended to a PCR (see block 420).

In general, the IME data is not directly written into one or more PCRs, but rather, it is accumulated (also referred to as “extended”). These integrity measurements are store within Platform Configuration Registers (PCRs) 431. A PCR is never written to, but rather, it is extended. The extended value is appended to the current measurement contained within the PCR and hashed, with the result replacing the contents of the PCR. This accumulation involves successive logical operations on results obtained during the integrity measurements, provided these logical operations can be duplicated for verification purposes. These logical operations may involve concatenation or some other type of arithmetic operations.

As illustrative examples, the accumulation may be conducted as a concatentation of measured results for the current integrity measurement and the hashed, IME data already placed in the PCR. Alternatively, the accumulation may be conducted by a concatentation of the hashed value of the measured results for the current integrity measurement and the hashed, IME data already placed in the PCR. The accumulation allows for sequencing of events so that a challenger can prove that one event occurred either before or after another.

More specifically, as shown in block 432, TPM 150 appends the received extend value from PCR 420 to the current PCR value 430. The result of the append operation is hashed and the resulting hashed value replaces the prior PCR contents (see blocks 434 and 436).

If a second component is to be measured, it undergoes a hash operation to produce an IME (IME2) associated with the measured second component (see block 440). An event log entry 445 is created for IME2 and IME 2 is extended (see block 450). While not required, for this example, this value is extended to the same PCR as shown in block 450. The TPM repeats the extend process described above with the ending value from the prior extend operating being the “current PCR value” for this operation.

Because the PCRs contain only accumulated hash values, the challenger may need the associated event data itself. This data is contained in an Integrity Management Event Log (IMEL) 460 which is the IME data as extended to the PCRS. During attestation, the contents of IMEL 460 may be accumulated and hashed for comparison with the IME data contained within the PCR.

III. Association of a Tick Count Value with an Actual Real-Time Value

In accordance with TPM Version 1.2 Specification, a mechanism for establishing an association between a tick count value (TCV) measured by a tick counter and measured real time by a clock source (e.g., external clock) is shown. This association is accomplished using a TPM Transport Session (TTS), where each TTS is associated with a particular tick counter. A set of TPM transactions can be grouped within a single TTS, and therefore, establishes a chronological relationship between themselves.

While the TPM itself contains no real-time clock source, it is possible to associate the ticks produced by a tick counter with actual time provided by a timing source external to the TPM. Of course, if future implementations of the TPM contain a real-time clock source, the tick counter may be adapted to be associated with actual time provided by this internal clock source.

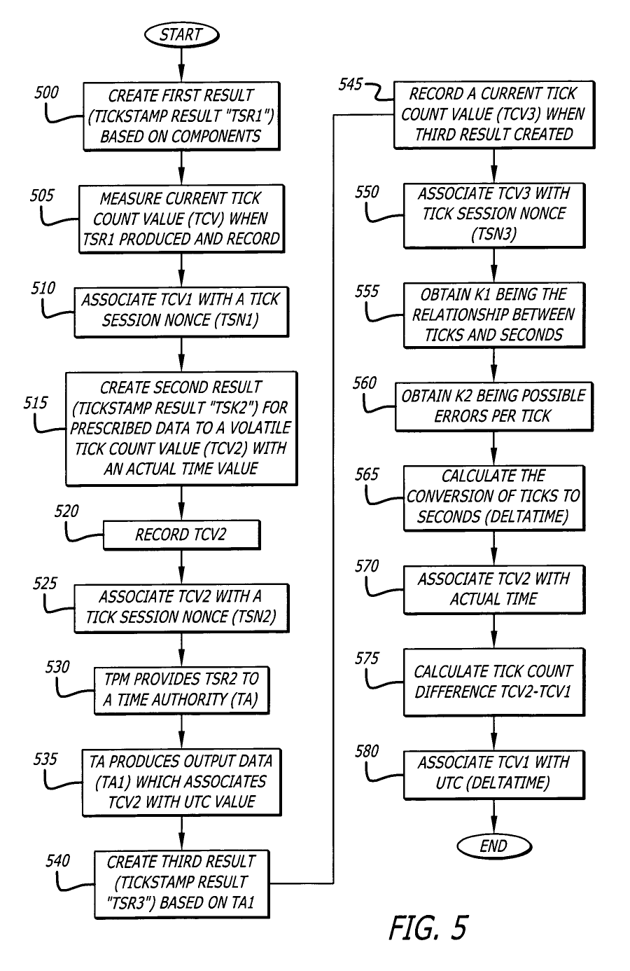

An illustrative embodiment of the protocol for associating a tick count with actual time is described below. For this illustration, a challenger desires to timestamp a component (e.g., specific software code to be executed within the computing platform). First, as set forth in block 500 of FIG. 5, the TPM performs TPM_TickStampBlob function on the component to create a first result for the component (sometimes referred to as a “TimeStamp result”). The current tick count value (TCV1), measured when the first result (TSR1) is created, is recorded by the TPM (block 505). Moreover, the TCV1 is associated with a tick session nonce (TSN1) used to initiate the current TTS (block 510).

Thereafter, the TPM needs to associate a tick count value with an actual time value. This may be accomplished by performing a TPM_TickStampBlob function on predetermined data (e.g., chosen alphanumeric text) to create a second result (block 515). The current tick count value (TCV2), measured when the second (TimeStamp) result (TSR2) is produced, is recorded by the TPM (block 520). Moreover, the TCV2 is associated with a tick session nonce (TSN2) as shown in block 525.

The TPM provides the TSR2 to a time authority which is responsible for timestamping incoming data (block 530). In essence, as shown in block 535, the time authority produces output data (TA1) which associates TCV2 with an actual time value referred to as a “universal time clock (UTC) value”. Thereafter, TPM now performs a TPM_TickStampBlob function on TA1. This creates a third (TimeStamp) result (block 540). The current tick count value (TCV3), measured when the third result (TSR3) is created, is recorded (block 545). Moreover, the TCV3 is associated with the tick session nonce (TSN3) as shown in block 550.

Therefore, the TPM has three TickStamp results (TSR1, TSR2, TSR3). The TPM knows that TSR2 was created before the UTC value. Moreover, the TPM also knows that TSR3 was created after the UTC value was computed. Thus, both TCV2 and TCV3 bound the UTC value as set forth below in equation (1).
TCV2<UTC<TCV3 (1)

This association holds true if TSN2 matches TSN3 to denote the same TPM Transport Session (TTS). If some event occurs that causes the TPM to create a new TSN and restart the tick count, then the TPM must start the association protocol all over again.

It is noted that the TPM has no information to determine when the UTC value occurred in the interval between TCV2 and TCV3. In fact, as noted in equation (2), a value generally equivalent to TCV3 minus TCV2 (hereinafter referred to as “TSRDELTA”) is the amount of uncertainty to which a TCV value should be associated with the UTC.
TSRDELTA=TCV3−TCV2 if and only if TSN2=TSN3 (2)

The TPM can obtain k1 (e.g., a predetermined value such as 0<k1<1), the relationship between ticks and seconds using a TPM_GetTicks command which returns current information concerning the TPM as set forth in a TCG published specification entitled “TPM Main Part 3 Commands Specification Version 1.2, Revision 62,” published on or around Oct. 2, 2003 (Page 176) The function returns a value of the number of ticks per microsecond. Using this value the amount of time per tick is easily calculated. Also, the TPM obtains k2 (e.g., predetermined value such as 0<k2≦1) being the possible errors per tick. This allows the TPM to calculate a conversion of ticks to a unit of actual time (e.g., seconds) and TSRDELTA parameter (hereinafter referred to as “DeltaTime”).

Mathematically, the association between TCV2 and the UTC value may be computed as set forth on Chapter 20.3 of the TPM Version 1.2 Specification.
DeltaTime=(k1*TSRDELTA)+(k2*TSRDELTA) (3)
DeltaTime=TimeChange+Drift, where TimeChange=k1*TSRDELTA & |Drift|<k2*TSRDELTA (4);
TCV2<UTC<TCV3 (5)
TCV2<UTC<TCV2+TCV3−TCV2 (6)
TCV2<UTC<TCV2+DeltaTime (7)
0<UTC−TCV2<DeltaTime (8)
0>TCV2−UTC <−(TimeChange+Drift) (9)
TimeChange/2>TCV2−UTC >−(TimeChange/2)−Drift (10)

Therefore, TCV2 is approximately equal to UTC−TimeChange/2 with an error constant equal to (TimeChange/2+|Drift|) as set forth in equation (11).
TCV2UTC−TimeChange/2 (11)

Provided TSN1 is equal to TSN2, denoting the same TTS, the TPM may similarly be configured to calculate a tick count difference between TCV2 and TCV1 and, knowing the conversion of ticks to seconds, an association between TCV1 and actual time or “UTC value” may be determined.

IV. Association of Integrity Measurement Events with Real-Time Values

In general, one embodiment of the invention features use of a tick counter within a TPM Transport Session. The tick counter is used to establish an association between actual time and any Integrity Measurement Event (IME) within an Integrity Metric Session (IMS).

Each command sent within a transport session is assigned a tick count by the TPM for that transport session. The tick count is incorporated into the session audit log, which is an accumulation of commands and return parameters sent during that session. That same tick count is also returned to the caller of the TPM function as part of the transport session return. This returned value is what is associated with the extend operation (or any other TPM command). While the tick count returned is not secure because it is not protect using a mechanism like a digital signature, it can be verified upon closing of the session by verifying the return values (which include the tick counts) with the signed transport session audit log.

According to one embodiment of the invention, this association is performed by extending IMEs into Platform Configuration Registers (PCRs) within an established TPM Transport Session (TTS) associated with the tick counter. While any command sent within the session will establish the beginning of the IMS, for this example, the first IME extend establishes a beginning of the IMS and is assigned a tick count value. Successive IMEs extends within the IMS will also be assigned tick count values. Thus, once actual time is associated with a particular IME (e.g., first IME extend), the actual time conducted for a targeted IME may be determined by ascertaining an absolute tick count difference between the first IME extend and the targeted IME. The challenger can therefore know when the events occurred relative to the beginning of the IMS.

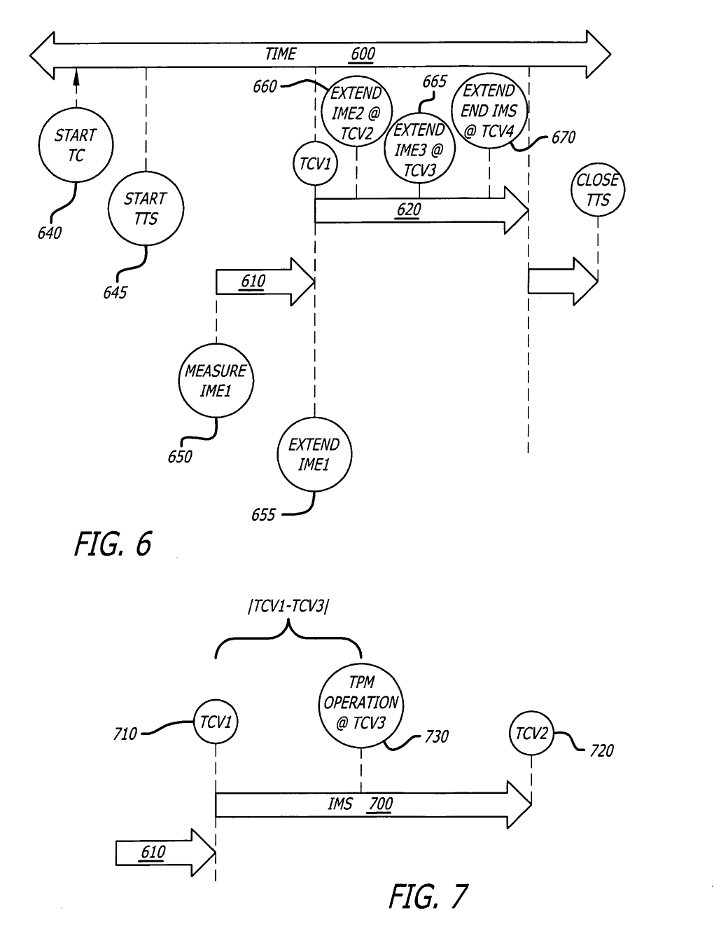

Referring now to FIG. 6, a first exemplary embodiment of a method for establishing a timestamp session over a predetermined duration of time 600 is shown. In general, a first timeline 610 represents an illustration of the time between a first measurement performed by code not constrained by the TTS and a first IME extend done within the TTS. Of course, it is not immediately possible to know when an IME was performed (or measured), only that it was performed prior to IME being extended which triggers a tick count. However, from the tick count, an approximation can be made of when the measurement was performed. A second timeline 620 represents the IMS being a series of IMEs having an absolute chronological relationship to each other as well as the beginning and end of the IMS.

It is contemplated that the calculation of the IME is typically performed using code that executes outside the transport session, thus restricting the association of the IME calculation with time. As a result, the calculation of the IME has no better time resolution than if the calculation occurred prior to the IME being extended. However, since the TPM provides a hashing function that can be done within the transport session, using this function, when desired, provides the time resolution of when the calculation of the IME was actually performed.

Initially, a tick counter (TC) is started, following by a TTS associated with the tick counter (items 640 and 645). The tick counter and TTS are started prior to the launch of IMS 620 because, during start-up of the computing platform, certain applications may be launched in a restricted code environment where an IMS cannot be started. For this illustrative embodiment, the IMS commences after a first integrity measurement (IMEL) and an extend of IME1 (items 650 and 655). The IME1 extend 655 constitutes an event within the TTS that triggers commencement of the IMS. The tick count value (TCV1) for IME1 extend 655 is recorded within the TPM.

During the IMS, the tick count values (TCV2, TCV3, TCV4) for each subsequent IME extend 660, 665, 670 are recorded. For this illustrative embodiment, an integrity measurement of a component relevant to the closing of the TTS is taken and an extend of that measurement is conducted at TCV4. At any point during the TTS, an entity trusted by the challenger may associate TCVx (1≦x≦4) with the actual time.

For instance, the first tick count value (TCV1) may be associated with an actual time. Since there is an absolute tick count difference between TCV1 and TCV2 (|TCV1-TCV2|), the tick count difference may be transformed into seconds using the GetTicks command which returns corresponding units of actual time between tick counts as described above. Therefore, the actual time associated with TCV2 will be the actual time measured for TCV1 plus the number of units of actual time corresponding in duration to the tick count difference |TCV1-TCV2|.

Alternatively, the association to actual time can be done prior to the closing of the TTS for any tick count value with the TTS. For instance, the third tick count value (TCV3) may be associated with an actual time. Thus, in order to compute the actual time measured at TCV2, the absolute tick count difference between TCV2 and TCV3 (|TCV2-TCV3|) is computed and the tick count difference is transformed into seconds. Therefore, the actual time associated with TCV2 will be the actual time measured for TCV3 minus the number of units of actual time corresponding in duration to the tick count difference |TCV2-TCV3|.

Referring to FIG. 7, a second exemplary embodiment of a method for creating a time stamp for a TPM operation, such as a digital signature conducted during an IMS, is shown. Herein, the computing platform commences an IMS 700 that begins at a first tick count value (TCV1) 710 and ends when a second tick count value (TCV2) is reached. This IMS may include IMES that, as described above, establish the time the components that participated in the digital signature were measured. During IMS 700, a TPM operation 730 is performed. This operation may include computing a digital signature for example. The TPM operation 730 will be assigned a third tick count value (TCV3) generated by a tick counter associated with the TTS during which IMS 700 is conducted.

If the challenger associates a tick count value (TCV1) at 710 with the actual time for example, the actual time of TPM operation 730 may be computed by the following operations: (i) determining an absolute tick count difference between the measured tick count values |TCV1-TCV3|; (ii) transforming the absolute tick count difference into units of actual time; and (iii) adding these units of actual time to the actual time measured at TCV1.

### V. ILLUSTRATIVE EXAMPLE

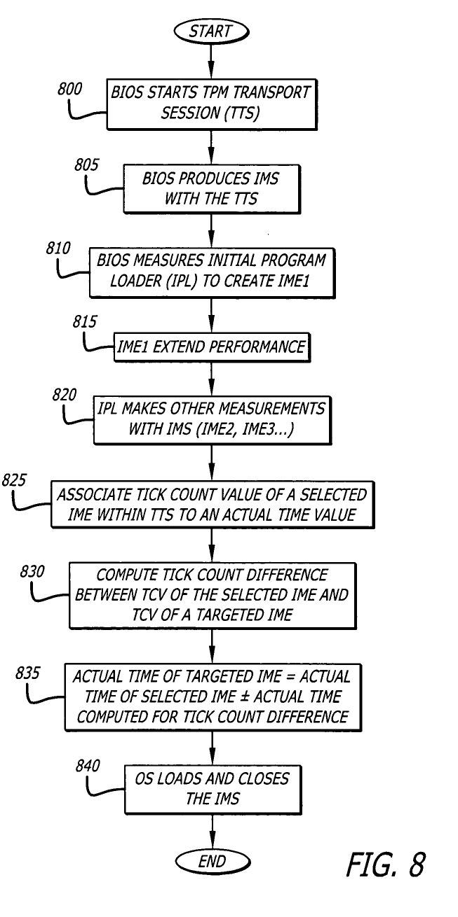

Referring now to FIG. 8, an exemplary embodiment of a timestamping operation to provide a verified time of when an operating system (OS) boots is shown. Per the TCG PC Client Specification, PCR[4] contains an Integrity Measurement Event (IME) of an Initial Program Loader (IPL). This is the code, usually on the first sector of the hard disk that boots the OS. A considerable amount BIOS code will execute prior to measuring and calling the IPL.

The BIOS will start a TPM transport session (TTS) producing an Integrity Measurement Session (IMS) (blocks 800 and 805). Within the IMS, the BIOS will measure the IPL creating IME1 (block 810). The BIOS will extend IME1 into PCR[4] within the IMS (block 815). The IPL may make other measurements within the IMS if desired to provide more resolution into the boot process (block 820). The OS loads and closes the IMS (block 840).

Either prior to closing the IMS or afterwards, the OS associates the tick count value (TCV1) with “actual time” using a protocol as described in TPM Version 1.2 Specification (see blocks 825-835). The “actual time” of TCV1 can be obtained by subtracting the number of ticks that have elapsed from TCV1 from the value of the tick counter's increment value (the relationship between the time between the TPM's tick and actual seconds) when the association between “actual time” and the tick counter is made. This time of IME1 is the time the OS booted.

While this invention has been described in terms of several illustrative embodiments, this description is not intended to be construed in a limiting sense. Various modifications of the illustrative embodiments, as well as other embodiments of the invention, are deemed to lie within the spirit and scope of the appended claims.

1. A method comprising:
conducting a first integrity measurement by a trusted platform module to produce a first integrity measurement event; and
creating an integrity time stamp associated with the first integrity measurement event by a trusted platform module, the integrity time stamp identifying an actual time when the first integrity measurement event was produced.

2. The method of claim 1, wherein the conducting of the first integrity measurement comprises:
starting a tick counter being associated with a timing session being established; and
conducting a plurality of integrity measurements including the first integrity measurement during the timing session to produce a corresponding plurality of integrity measurement events including the first integrity measurement event.

3. The method of claim 2, wherein the timing session is a transport session conducted within a Trusted Platform Module.

4. The method of claim 2, wherein the creating of the integrity time stamp comprises:
recording a tick count value, each tick count value representing a recorded number of tick counts for integrity measurement event of the plurality of integrity measurement events;
associating actual time with a second integrity measurement event of the plurality of integrity measurement events;
computing a tick count difference between a tick count value for the second integrity measurement event and a tick count value for the first integrity measurement event;
ascertaining a timing relationship between a tick count and a unit of actual time;
computing a period of actual time associated with the tick count difference; and
computing the actual time when the first integrity measurement event was produced by adding the actual time when the second integrity measurement event was produced and the period of actual time.

5. The method of claim 2, wherein the creating of the integrity time stamp comprises:
recording a tick count value for each integrity measurement event of the plurality of integrity measurement events, each tick count value representing a recorded number of tick counts;
associating actual time with a second integrity measurement event of the plurality of integrity measurement events;
computing a tick count difference between tick count value for the second integrity measurement event and a tick count value for the first integrity measurement event;
ascertaining a timing relationship between a tick count and a unit of actual time;
computing a period of actual time associated with the tick count difference; and
computing the actual time when the first integrity measurement event was produced by subtracting the period of actual time from the actual time when the second integrity measurement event was produced.

6. The method of claim 2, wherein the creating of the integrity time stamp comprises:
recording a tick count value for each integrity measurement event of the plurality of integrity measurement events; and
associating actual time with a tick count value for the first integrity measurement event of the plurality of integrity measurement events.

7. The method of claim 1, wherein the conducting of the first integrity measurement is performed by a hashing function within the Trusted Platform Module.

8. The method of claim 3, wherein the conducting of the plurality of integrity measurements are performed by hashing function within the Trusted Platform Module.

9. Software stored within machine readable medium and executed by logic within a Trusted Platform Module (TPM), comprising:
software code to conduct a first integrity measurement by the TPM to produce a first integrity measurement event; and
software code to create an integrity time stamp associated with the first integrity measurement event by the TPM, the integrity time stamp identifying an actual time when the first integrity measurement event was produced.

10. The software of claim 9, wherein the software code to conduct the first integrity measurement further comprises code for (i) starting a tick counter being associated with a TPM transport session being established and (ii) conducting a plurality of integrity measurements including the first integrity measurement during the TPM transport session to produce a corresponding plurality of integrity measurement events including the first integrity measurement event.

11. The software of claim 9, wherein the software code to create the integrity time stamp by
recording a tick count value for each integrity measurement event of the plurality of integrity measurement events, each tick count value representing a number of tick counts;
associating actual time with a second integrity measurement event of the plurality of integrity measurement events;
computing a tick count difference between a tick count value for the second integrity measurement event and a tick count value for the first integrity measurement event;
ascertaining a timing relationship between a tick count and a unit of actual time;
computing a period of actual time associated with the tick count difference; and
computing the actual time when the first integrity measurement event was produced by adding the actual time when the second integrity measurement event was produced and the period of actual time.

12. The software of claim 10, wherein the software code to create the integrity time stamp by:
recording a tick count value for each integrity measurement event of the plurality of integrity measurement events each tick count value representing a number of tick counts;
associating actual time with a second integrity measurement event of the plurality of integrity measurement events;
computing a tick count difference between the tick count value for the second integrity measurement event and a tick count value for he first integrity measurement event;
ascertaining a timing relationship between a tick count and a unit of actual time;
computing a period of actual time associated with the tick count difference; and
computing the actual time when the first integrity measurement event was produced by subtracting the period of actual time from the actual time when the second integrity measurement event was produced.

13. The software of claim 10, wherein the software code to create the integrity time stamp by:
recording a tick count value for each integrity measurement event of the plurality of integrity measurement events; and
associating actual time with a tick cont value for the first integrity measurement event of the plurality of integrity measurement events.

14. A computing platform comprising:
a processor; and
interface logic coupled to the processor; and
a trusted platform module (TPM) coupled to the interface logic via an interconnect, the TPM being adapted to (i) conduct a plurality of integrity measurements for a plurality of components to produce a corresponding plurality of integrity measurement events, and (ii) create an integrity time stamp associated with a first integrity measurement event of the plurality of integrity measurement events, the integrity time stamp identifying an actual time when the first integrity measurement event was produced.

15. The computing platform of claim 14, wherein the TPM is further adapted to provide both the first integrity measurement event and the integrity time stamp during attestation.

16. The computing platform of claim 15, wherein the TPM is further adapted to store a form of the plurality of integrity measurement events within memory contained within the TPM.

17. The computing platform of claim 14, wherein the TPM starts a tick counter prior to conducting the plurality of integrity measurements and starts a TPM Transport Session in response to a specific type of integrity measurement event produced prior to the first integrity measurement event.

18. The computing platform of claim 17, wherein the TPM creates the integrity time stamp for the first integrity measurement event by
recording a tick count value for each integrity measurement event of the plurality of integrity measurement events, each tick count value representing a number of tick counts;
associating actual time with a second integrity measurement event of the plurality of integrity measurement events;
computing a tick count difference between a tick count value for the second integrity measurement event and a tick count value for the first integrity measurement event;
ascertaining a timing relationship between a tick count and a unit of actual time;
computing a period of actual time associated with the tick count difference; and
computing the actual time when the first integrity measurement event was produced by adding the actual time when the second integrity measurement event was produced and the period of actual time.

19. The method of claim 17, wherein the TPM creates the integrity time stamp for the first integrity measurement event by
recording a tick count value for each integrity measurement event of the plurality of integrity measurement events, each tick count value representing a number of tick counts;
associating actual time with a second integrity measurement event of the plurality of integrity measurement events;
computing a tick count difference between a tick count value for the second integrity measurement event and a tick count value for the first integrity measurement event;
ascertaining a timing relationship between a tick count and a unit of actual time;
computing a period of actual time associated with the tick count difference; and
computing the actual time when the first integrity measurement event was produced by subtracting the period of actual time from the actual time when the second integrity measurement event was produced.
